(19) United States
(12) Patent Application Publication
(10) Pub. No.: US 2025/0342856 A1
(43) Pub. Date: Nov. 6, 2025

(54) Phase-Coherent In-Line VCSEL Array with Slider Trailing Mount for HAMR

(71) Applicant: Western Digital Technologies, Inc., San Jose, CA (US)

(72) Inventors: Barry C. STIPE, San Jose, CA (US); Takuya MATSUMOTO, San Jose, CA (US); Hossein TAHERI, San Jose, CA (US); Wan KUANG, San Jose, CA (US)

(73) Assignee: Western Digital Technologies, Inc., San Jose, CA (US)

(21) Appl. No.: 19/271,443

(22) Filed: Jul. 16, 2025

Related U.S. Application Data
(63) Continuation-in-part of application No. PCT/US2024/012257, filed on Jan. 19, 2024.
Application No. PCT/US2024/012257 is a continuation of application No. 18/230,018, filed on Aug. 3, 2023, now Pat. No. 12,040,001.
(60) Provisional application No. 63/523,839, filed on Jun. 28, 2023.

(51) Int. Cl. G11B 5/48; G11B 5/00; G11B 13/08

(52) U.S. Cl. CPC G11B 5/4866; G11B 13/08; G11B 2005/0021; G11B 2209/02

(57) ABSTRACT

The present disclosure relates to pretreating a magnetic recording head assembly for magnetic media drive. The magnetic recording head assembly comprises a slider having a media facing surface (MFS), a top surface disposed opposite the MFS, a trailing edge surface disposed adjacent to the top surface, and an optical grating disposed on the trailing edge surface. A vertical cavity surface emitting laser (VCSEL) device is mounted to the trailing edge surface of the slider. The VCSEL device is aligned with the optical grating. A magnetic recording head comprising a waveguide having a grating pattern and a light output pattern. The light output pattern can output in-phase or out-of-phase light. The grating pattern aligns with the optical grating and comprises a plurality of grating bumps. The grating bumps may comprise a high index material, and may have different dimensions.

### CROSS-REFERENCE TO RELATED APPLICATIONS

This application is a continuation-in-part of co-pending PCT patent application Serial No. PCT/US2024/012257, filed Jan. 19, 2024, which claims benefit of U.S. Pat. No. 12,040,001, issued Jul. 16, 2024, which was filed as U.S. patent application Ser. No. 18/230,018 on Aug. 3, 2023, which claims benefit of U.S. provisional patent application Ser. No. 63/523,839, filed Jun. 28, 2023, each of which is herein incorporated by reference.

### BACKGROUND OF THE DISCLOSURE

### Field of the Disclosure

Embodiments of the present disclosure generally relate to a magnetic recording head for a magnetic media drive.

### Description of the Related Art

The heart of the functioning and capability of a computer is the storing and writing of data to a data storage device, such as a magnetic media drive (e.g., hard disk drive (HDD)). The volume of data processed by a computer is increasing rapidly. There is a need for higher recording density of a magnetic recording medium to increase the function and the capability of a computer.

In order to achieve higher recording densities, such as recording densities exceeding 2 Tbit/in² for a magnetic recording medium, the width and pitch of write tracks are narrowed, and thus the corresponding magnetically recorded bits encoded in each write track is narrowed. One challenge in narrowing the width and pitch of write tracks is decreasing a surface area of a main pole of the magnetic recording write head at a media facing surface (MFS). As the main pole becomes smaller, the recording field becomes smaller as well, limiting the effectiveness of the magnetic recording write head.

Heat-assisted magnetic recording (HAMR) and microwave assisted magnetic recording (MAMR) are two types of energy-assisted magnetic recording (EAMR) technology to improve the recording density of a magnetic recording medium. In HAMR, a laser source is located next to or near the write element of the magnetic recording write head in order to produce heat, such as a laser source exciting a near-field transducer (NFT) to produce heat at a write location of a magnetic recording medium. The laser source is often disposed on top of a slider, which adds extra height to the magnetic recording assembly. The added height thus increases disk-to-disk spacing within the magnetic recording assembly, limiting the amount of disks and negatively impacting the capacity of the drive.

Therefore, there is a need in the art for an improved HAMR magnetic media drive.

### SUMMARY OF THE DISCLOSURE

The present disclosure relates to pretreating a magnetic recording head assembly for magnetic media drive. The magnetic recording head assembly comprises a slider having a media facing surface (MFS), a top surface disposed opposite the MFS, a trailing edge surface disposed adjacent to the top surface, and an optical grating disposed on the trailing edge surface. A vertical cavity surface emitting laser (VCSEL) device is mounted to the trailing edge surface of the slider. The VCSEL device is aligned with the optical grating. A magnetic recording head comprising a waveguide having a grating pattern and a light output pattern. The light output pattern can output in-phase or out-of-phase light. The grating pattern aligns with the optical grating and comprises a plurality of grating bumps. The grating bumps may comprise a high index material, and may have different dimensions.

In one embodiment, a magnetic recording head assembly comprises a slider, comprising: a media facing surface, a top surface opposite the media facing surface, a trailing edge surface adjacent to the top surface, a leading edge surface opposite the trailing edge surface, and an optical grating disposed on the trailing edge surface, a vertical cavity surface emitting laser (VCSEL) device coupled to the trailing edge surface of the slider, the VCSEL device disposed over the optical grating, and a magnetic recording head disposed on the trailing edge surface of the slider, the magnetic recording head comprising a waveguide, wherein the waveguide comprises: a grating active area aligned with the optical grating, the grating active comprising a plurality of grating bumps, and a light output pattern.

In another embodiment, a magnetic recording head assembly comprise a slider, comprising: a media facing surface, a top surface opposite the media facing surface, a trailing edge surface adjacent to the top surface, a leading edge surface opposite the trailing edge surface, an optical grating disposed on the trailing edge surface, and a mechanical stop disposed adjacent to the optical grating, a vertical cavity surface emitting laser (VCSEL) device coupled to the trailing edge surface of the slider, the VCSEL device comprising a notch, wherein the notch aligns with the mechanical stop, and a magnetic recording head disposed on the trailing edge surface of the slider, the magnetic recording head comprising a waveguide.

In yet another embodiment, a magnetic recording head assembly a slider, comprising: a media facing surface, a top surface opposite the media facing surface, a trailing edge surface adjacent to the top surface, a leading edge surface opposite the trailing edge surface, an optical grating disposed on the trailing edge surface, one or more heat sinks disposed adjacent to the optical grating, and a mechanical stop disposed adjacent to the optical grating, a vertical cavity surface emitting laser (VCSEL) device coupled to the trailing edge surface of the slider, the VCSEL device comprising a notch and one or more contact pads, wherein the notch aligns with the mechanical stop, and wherein the one or more contact pads align over the one or more heat sinks, and the magnetic recording head comprising a waveguide, wherein the waveguide comprises: a grating active area aligned with the optical grating, the grating active comprising a plurality of grating bumps, and a light output pattern.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic illustration of certain embodiments of a magnetic media drive including a HAMR magnetic write head.

FIG. 2 is a schematic illustration of a cross sectional side view of a HAMR write head facing a magnetic disk.

FIGS. 3A-3B illustrate a magnetic recording head assembly, according to one embodiment.

FIGS. 3C-3D illustrate a VCSEL device of the magnetic recording head assembly, according to one embodiment.

FIGS. 4A-4B illustrate a magnetic recording head assembly where the VCSEL array is mounted on the trailing edge of the slider, according to another embodiment.

FIGS. 4C-4F illustrate a VCSEL device of the magnetic recording head assembly of FIGS. 4A-4B, according to various embodiments.

FIGS. 5A-5E illustrate various grating active areas of the waveguide of FIGS. 4A-4B, according to various embodiments.

FIGS. 6A-6F illustrate light output designs of the waveguide of FIGS. 4A-4B, according to various embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure relates to pretreating a magnetic recording head assembly for magnetic media drive. The magnetic recording head assembly comprises a slider having a media facing surface (MFS), a top surface disposed opposite the MFS, a trailing edge surface disposed adjacent to the top surface, and an optical grating disposed on the trailing edge surface. A vertical cavity surface emitting laser (VCSEL) device is mounted to the trailing edge surface of the slider. The VCSEL device is aligned with the optical grating. A magnetic recording head comprising a waveguide having a grating pattern and a light output pattern. The light output pattern can output in-phase or out-of-phase light. The grating pattern aligns with the optical grating and comprises a plurality of grating bumps. The grating bumps may comprise a high index material, and may have different dimensions.

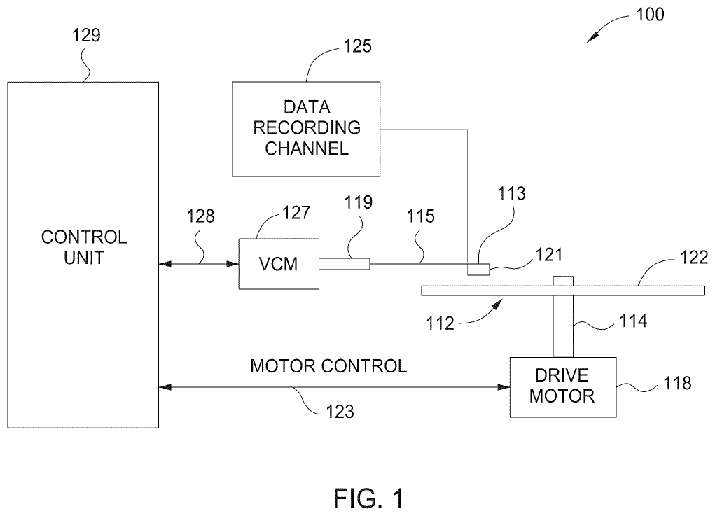

FIG. 1 is a schematic illustration of certain embodiments of a magnetic media drive 100 including an energy-assisted magnetic recording (EAMR) write head, such as a heat-assisted magnetic recording (HAMR) or microwave assisted magnetic recording (MAMR) write head. Such magnetic media drive may be a single drive/device or comprise multiple drives/devices. For the ease of illustration, a single disk drive 100 is shown according to one embodiment. The disk drive 100 includes at least one rotatable magnetic recording medium 112 (oftentimes referred to as magnetic disk 112) supported on a spindle 114 and rotated by a drive motor 118. The magnetic recording on each magnetic disk 112 is in the form of any suitable patterns of data tracks, such as annular patterns of concentric data tracks (not shown) on the magnetic disk 112.

At least one slider 113 is positioned near the magnetic disk 112. Each slider 113 supports a head assembly 121 including one or more read heads and one or more write heads such as a HAMR write head. As the magnetic disk 112 rotates, the slider 113 moves radially in and out over the disk surface 122 so that the head assembly 121 may access different tracks of the magnetic disk 112 where desired data are written. Each slider 113 is attached to an actuator arm 119 by way of a suspension 115. The suspension 115 provides a slight spring force which biases the slider 113 toward the disk surface 122. Each actuator arm 119 is attached to an actuator 127. The actuator 127 as shown in FIG. 1 may be a voice coil motor (VCM). The VCM includes a coil movable within a fixed magnetic field, the direction and speed of the coil movements being controlled by the motor current signals supplied by control unit 129.

During operation of the disk drive 100, the rotation of the magnetic disk 112 generates an air bearing between the slider 113 and the disk surface 122 which exerts an upward force or lift on the slider 113. The air bearing thus counter-balances the slight spring force of suspension 115 and supports slider 113 off and slightly above the disk surface 122 by a small, substantially constant spacing during normal operation.

The various components of the disk drive 100 are controlled in operation by control signals generated by control unit 129, such as access control signals and internal clock signals. Typically, the control unit 129 comprises logic control circuits, storage means, and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on magnetic disk 112. Write and read signals are communicated to and from the head assembly 121 by way of recording channel 125. Certain embodiments of a magnetic media drive of FIG. 1 may further include a plurality of media, or disks, a plurality of actuators, and/or a plurality number of sliders.

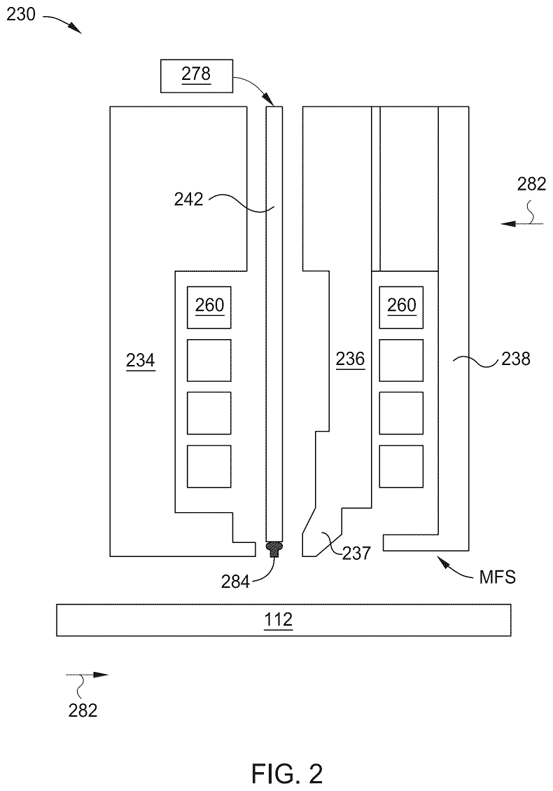

FIG. 2 is a schematic illustration of certain embodiments of a cross sectional side view of a HAMR write head 230 facing a magnetic disk 112. The HAMR write head 230 may correspond to part of the reading/recording head assembly 121 described in FIG. 1 or a recording head used in other magnetic media drives. The HAMR write head 230 includes a media facing surface (MFS), such as an air bearing surface (ABS) or a gas bearing surface (GBS), facing the disk 112. As shown in FIG. 2, the magnetic disk 112 and the HAMR write head 230 relatively moves in the direction indicated by the arrows 282 (need to change direction).

The HAMR write head 230 includes a main pole 236 disposed between a leading return shield 234 and a trailing return shield 238. The main pole 236 can include a main pole tip 237 at the MFS. The main pole tip 237 can include or not include a leading taper and/or a trailing taper. A coil 260 around the main pole 236 excites the main pole tip 237 to produce a writing magnetic field for affecting a magnetic medium of the rotatable magnetic disk 112. The coil 260 may be a helical structure or one or more sets of pancake structures. The leading return shield 234 and/or the trailing return shield 238 can act as the return pole for the main pole 236.

The magnetic disk 112 is positioned adjacent to or under the HAMR write head 230. A magnetic field produced by current in the coil 260 is used to control the direction of magnetization of bits in the magnetic disk 112.

The HAMR write head 230 includes a structure for heating the magnetic disk 112 proximate to where the main pole tip 237 applies the magnetic write field to the storage media. A waveguide 242 is positioned between the main pole 236 and the leading return shield 234. The waveguide 242 can includes a core layer and a cladding layer surrounding the core layer. The waveguide 242 conducts light from a light source 278 of electromagnetic radiation, which may be, for example, ultraviolet, infrared, or visible light. The light source 278 may be, for example, an edge emitting laser diode (EELD) or a vertical cavity surface emitting laser (VCSEL) device, a laser diode, or other suitable laser light source for directing a light beam toward the waveguide 242.

Various techniques that are known for coupling the light source 278 into the waveguide 242 may be used. For example, the light source 278 may work in combination with an optical fiber and external optics for directing a light beam to the waveguide 242. Alternatively, the light source 278 may be mounted on the waveguide 242 and the light beam may be directly coupled into the waveguide 242 without the need for external optical configurations. Once the light beam is coupled into the waveguide 242, the light propagates through the waveguide and heats a portion of the media, as the media moves relative to the HAMR write head 230 as shown by arrows 282.

The HAMR write head 230 can include a near-field transducer (NFT) 284 to concentrate the heat in the vicinity of the end of the waveguide 242. The NFT 284 is positioned in or adjacent to the waveguide 242 near or at the MFS. Light from the waveguide 242 is absorbed by the NFT 284 and excites surface plasmons which travel along the outside of the NFT 284 towards the MFS concentrating electric charge at the tip of the NFT 284 which in turn capacitively couples to the magnetic disk and heats a precise area of the magnetic disk 112 by Joule heating. One possible NFT 284 for the HAMR write head is a lollipop design with a disk portion and a peg extending between the disk and the MFS. The NFT 284 absorbs heat from the waveguide light which can have a negative effect on reliability of the HAMR write head 230. Surrounding metal is used as a heatsink to minimize the temperature.

Optical power from an external coherent light source (i.e., EELD, surface emitting diode laser, VCSEL device, or fiber coupled diode laser) is coupled into the PLC of the HAMR head slider through the SSC or mode converter. The basic design concept is to match the mode profile of the incoming light source and the mode profile of the PLC, both at the coupling interface, hence maximizing the overall coupling efficiency.

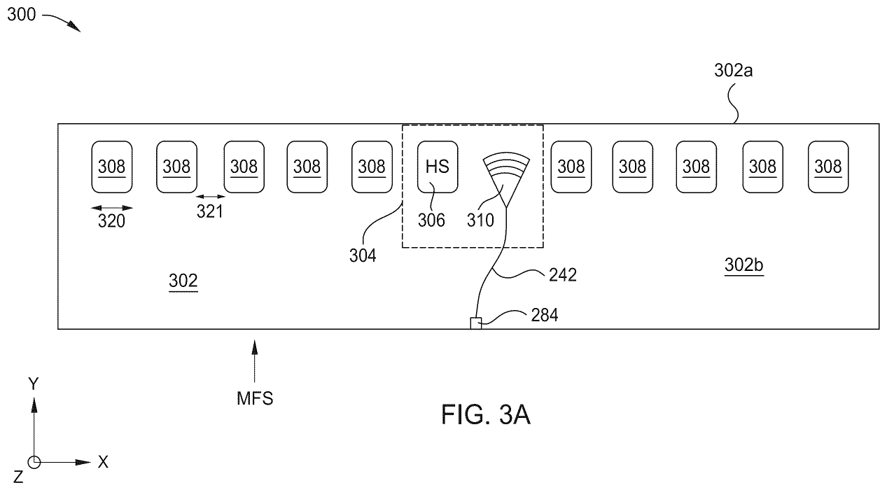

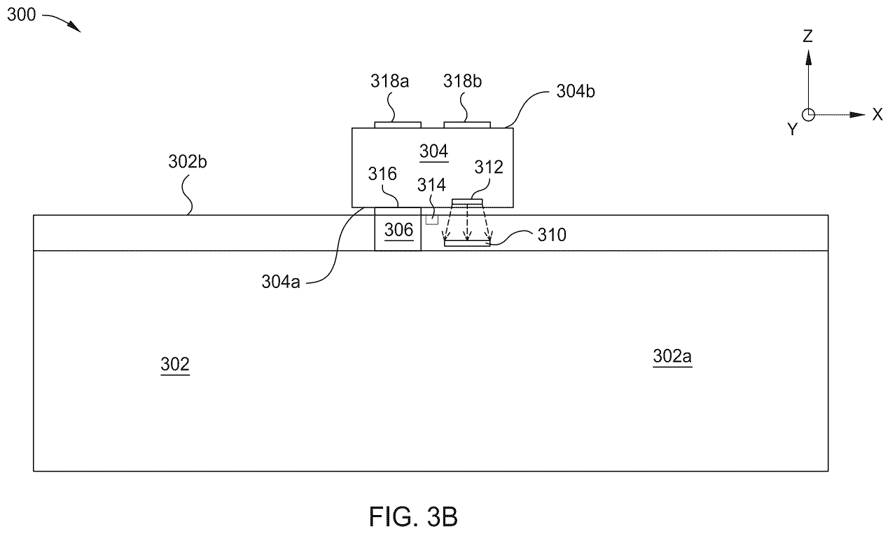

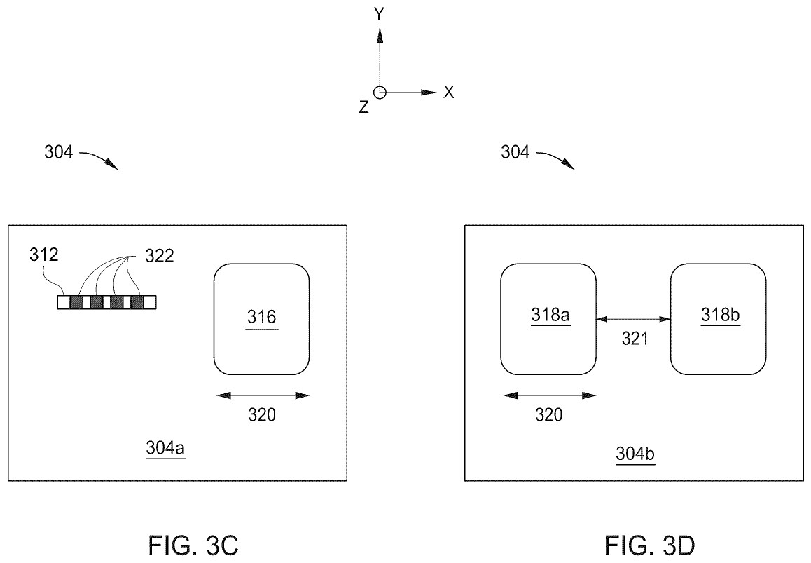

While FIG. 2 shows a general configuration of a HAMR recording head, FIGS. 3A-3B illustrate a magnetic recording head assembly 300 where the VCSEL array is mounted on the trailing edge of the slider, according to one embodiment. FIG. 3A illustrates a trailing edge surface 302b view of the magnetic recording head assembly 300, and FIG. 3B illustrates a top view of the magnetic recording head assembly 300. FIGS. 3C-3D illustrate a VCSEL device 304 of the magnetic recording head assembly 300, according to one embodiment. FIG. 3C illustrates a front or output surface 304a (or a slider facing surface) of the VCSEL device 304, and FIG. 3D illustrates a back surface 304b (or suspension tab facing surface) of the VCSEL device 304. The magnetic recording head assembly 300 may be used in combination with the HAMR write head 230 of FIG. 2, and may correspond to part of the reading/recording head assembly 121 described in FIG. 1 or a recording head used in other magnetic media drives.

As the slider 302 and a magnetic recording head 314 move over a rotating media, such as a disk, one side of the slider 302 leads, or passes over the media, while the opposite side trails, or passes over the media last. As used herein, the trailing edge surface 302b of the slider 302 refers to the side of the slider 302 that passes over the media last. The magnetic recording head 314 may incorporate elements of the HAMR head 230 of FIG. 2. However, unlike the light source 278 in FIG. 2 that is mounted on the top surface of the slider, FIGS. 3A-3D show a VCSEL device 304 mounted on this trailing edge surface 302b of the slider 302. With further reference to FIG. 3A, the slider 302 comprises a top surface 302a disposed opposite a MFS, a leading edge surface disposed adjacent to the top surface 302a, a trailing edge surface 302b disposed opposite the leading edge surface, and a media facing surface disposed opposite the top surface 302a.

The magnetic recording head assembly 300 comprises a slider 302 having a plurality of contact pads 308, such as 2 contact pads to 32 contact pads, disposed there on the trailing edge surface 302b of the slider 302 (which is adjacent to a top surface 302a) to contact or connect to a suspension (not shown; the suspension may be the suspension 115 of FIG. 1). The slider 302 comprises ceramic, for example. The contact pads 308 each has a first width 320 of about 25 μm or greater, where the spacing 321 between adjacent contact pads 308 is about 32 μm. The previously listed values are not intended to be limiting, but to provide an example of an embodiment. A heat sink contact pad or stud 306 is disposed adjacent to a contact pad 308. The heat sink contact pad 306 may have the same width 320 as the contact pads 308, and may be spaced the distance 321 from the adjacent contact pad 308. These contact pads provide electrical connection points for the disk drive circuitry to power and control the magnetic recording head on the slider. The contact pads connect to electrical paths routed through a suspension of the disk drive.

An optical grating 310 is disposed between the heat sink stud 306 and a contact pad 308. The optical grating 310 may be part of the planar lightwave circuit (PLC). In some embodiments, the optical grating 310 is disposed on core materials of the waveguide 242, such as Ta₂O₅ or Nb₂O₅. The recording head 314 is disposed on the trailing edge surface 302b of the slider 302, as shown in FIG. 3B. The dotted line box illustrates where a VCSEL device 304 will be attached to the slider 302 on the trailing edge surface 302b, like shown in FIG. 3B. The VCSEL device 304 is disposed over and aligned with the heat sink stud 306 and the grating 310, as discussed further below. The grating 310 is coupled to the waveguide 242 of the recording head 314, and the waveguide 242 is coupled to the NFT 284 of the recording head 314. The NFT 284 is disposed at a MFS, like described above in FIG. 2.

The optical grating 310 directs light output from a coherent VCSEL array 312 into the waveguide 242. The grating 310 comprises a high index dielectric material having a repeating diffraction pattern that redirects light from the VCSEL array 312 and turns or directs the light about 90 degrees into the waveguide 242 (i.e., in the −-direction). The grating 310 may be curved and/or blazed (e.g., wedge-shaped) to couple the laser output of the VCSEL array 312 into the tapered waveguide 242. The period of the optical grating 310 is matched to half the effective wavelength of the light, as is known in the art. The waveguide 242 then directs the light from the grating 310 to the NFT 284 at the MFS.

As shown in FIG. 3B, the VCSEL device 304 is mounted to the trailing edge surface 302b of the slider 302 via a first electrode of contact pad 316. A first electrode or contact pad 316 is disposed adjacent to the coherent VCSEL array 312 on a front or recording head facing surface 304a of the VCSEL device 304, like shown in FIG. 3C. The first contact pad 316 mounts to the heat sink stud 306 in order to draw heat away from the VCSEL array 312 and into the ceramic slider 302. The first contact pad 316 may have the same width 320 as the contact pads 308. The heat sink stud 306 is disposed on the magnetic recording head 314 (shown here as a rectangle to represent the various layers of the recording head 314). The VCSEL array 312 aligns with the grating 310 in order to output light to the grating 310. The waveguide 242 and the NFT 284 are not shown in FIG. 3B, as they are located below the grating 310 in the −y-direction (e.g., into the page).

The VCSEL device 304 further comprises a second contact pad or electrode 318a and a third contact pad or electrode 318b disposed on a back surface 304b of VCSEL device 304, like shown in FIG. 3D. The back surface 304b is opposite the front surface 304a of the VCSEL device 304. The second contact pad 318a and the third contact pad 318b are each connected to the suspension, similar to the plurality of contact pads 308, and to the laser diode of the VCSEL array 312 to allow current to flow through the laser diode. The second contact pad 318a is further connected to the laser substrate and the third contact pad 318b is isolated from the laser substrate (or vice versa). Rather, the third contact pad 318b extends through the VCSEL device 304 to connect to the laser diode of the VCSEL array 312 to energize the lasers of the VCSEL array 312. The current return path is to the laser substrate and the contact pad 318a. The second and third contact pads 318a, 318b may have the same dimensions and spacing as the plurality of contact pads 308.

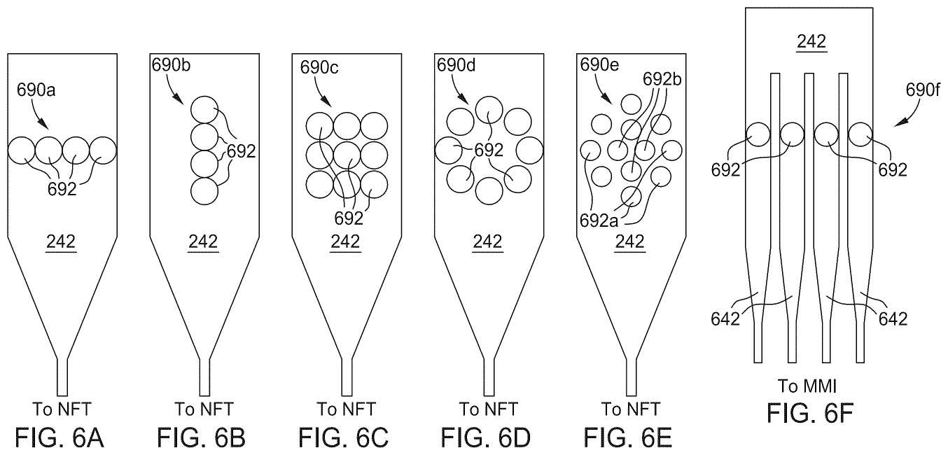

As shown in FIG. 3C, the VCSEL array 312 comprises a plurality of apertures 322 through which a plurality of lasers are output to the grating 310. The plurality of apertures 322 of the VCSEL array 312 may be linear, or arranged in a 2D array, as discussed below in FIGS. 6A-6F. The number of apertures 322 corresponds to the number of lasers of the VCSEL array 312. While four apertures 322 are shown, the VCSEL array 312 may comprise any number of apertures 322, such as 2 apertures and lasers to 32 apertures and lasers. Each aperture 322 has a size of about 1 μm to about 10 μm. Each aperture 322 is spaced from an adjacent aperture 322 a distance in the x-direction of about 2 μm to about 20 μm. The output laser power per aperture 322 is about 0.5 mW to about 10 mW. The light output from the VCSEL apertures 322 is coherent and in-phase (e.g., the output light is like a single beam).

The lasers output from the VCSEL array 312 are all in-phase, rather than being 180 degrees out-of-phase (i.e., 0 degrees out-of-phase), for example, and have no mode hopping. Other VCSEL arrays 312 contemplated herein may be out-of-phase, as discussed further below. Furthermore, each of the plurality of lasers emitted by the VCSEL array 312 operates at the same frequency and are phase coherent. Each of the plurality of lasers have single mode outputs and a defined polarization direction. The plurality of lasers each has an active region (e.g., an area where the laser excited electrons). These active regions are spaced close enough to enable coupling and phase coherence to occur.

By mounting the VCSEL device 304 onto the trailing edge surface 302b of the slider 302, the overall height of the magnetic recording head assembly 300 is reduced, thus allowing for a reduced disk-to-disk spacing, a potentially increased number of disks, and increased HDD capacity. Furthermore, when VCSEL chips are mounted to a top surface of the slider, side electrodes are often utilized for making connection to the suspension. However, the side electrodes or contacts increase the complexity and cost of the VCSEL chip. By mounting the VCSEL device 304 to the trailing edge surface 302b, electrodes or contact pads 316, 318a, 318b are only needed on the back surface 304b and the front surface 304a of the VCSEL device 304. Thus, mounting the VCSEL device 304 to the trailing edge surface 302b of the slider 302 reduces complexity and costs during fabrication while also reducing the height of the magnetic recording head assembly 300, reducing the disk-to-disk spacing, and increasing the capacity of the magnetic recording drive.

VCSELs have a number of significant advantages for use as the light source in HAMR. The edge emitting laser diode (EELD) used is typically mounted to a sub-mount because it is difficult to bond the edge-emitting facet face of the laser directly to the top of the slider. This sub-mount is then bonded to the slider. A VCSEL can easily have bonding electrodes on the surface-emitting face which match to corresponding electrodes on the trailing edge surface of the slider, which when utilized with a grating, is able to output light from the trailing edge surface onto the grating, which then directs the light at a 90 degree angle to the waveguide. These electrodes can be bonded together by laser-assisted solder reflow and can also serve as electrical connections for energizing the laser.

By eliminating the need for a sub-mount, the light source cost can be significantly reduced. The VCSEL laser facet is made in a wafer level process which further lowers cost relative to EELDs. A VCSEL output beam is also larger and more circular than that of an EELD which increases the alignment tolerance and coupling efficiency to the slider spot size convertor. VCSELs are known to have higher reliability than EELDs due to larger, less intense optical mode and the wafer facet process. As a result, VCSELs do not require burn-in during manufacturing which further lowers cost. Since the VCSEL cavity length is shorter than EELDs, and because the laser is mounted on the trailing edge surface of the slider, the lower overall height allows for a reduced disk-to-disk spacing, potentially more disks, and for higher HDD capacity.

Further, VCSELs have mode hop-free operation due to very short cavity length with one longitudinal mode and DBR mirror selectivity while EELDs suffer from mode hops. Mode hopping can cause a small (typically 1-2%) change in laser power to suddenly occur during the recording process. The possibility of a track width change and bit shift must be accounted for, which reduces the capacity of the HDD.

The primary technical issue with VCSELs is the relatively low output power relative to EELDs. Multimode VCSELs can have larger output power than single mode VCSELs but single mode operation is required by the waveguides and NFTs that are used to create the heat spot in the disk for HAMR. Single mode VCSELs typically have only about 2 mW of maximum output power, far short of the 10 mW to 20 mW needed for HAMR. The output cannot be efficiently increased by combining the outputs from multiple separate VCSELs because of decoherence between the wave fronts. If the active region of adjacent VCSELs are brought very close together, the wave functions will overlap enough to create coupling and phase coherence between their outputs. With the right VCSEL design and light delivery scheme, these outputs may be combined into a single waveguide with the necessary 5 mW to 10 mW of single mode power needed by the NFT for HAMR.

In one embodiment, a magnetic recording head assembly comprises a slider, comprising: a media facing surface, a top surface opposite the media facing surface, a trailing edge surface adjacent to the top surface, a leading edge surface opposite the trailing edge surface, and an optical grating disposed on the trailing edge surface, a vertical cavity surface emitting laser (VCSEL) device coupled to the trailing edge surface of the slider, the VCSEL device disposed over the optical grating, and a magnetic recording head disposed on the trailing edge surface of the slider.

The VCSEL device is capable of emitting a plurality of lasers that are phase coherent. The VCSEL device is capable of emitting the plurality of lasers through a plurality of laser apertures onto the optical grating. An output laser power per laser aperture is about 0.5 mW to about 10 mW, and wherein the plurality of laser apertures is 2 apertures to 32 apertures. The magnetic recording head comprises a waveguide and a near field transducer (NFT) coupled to the waveguide, the waveguide extending from a top surface of the magnetic recording head to the NFT, the NFT being disposed at the media facing surface. The optical grating is capable of directing light output from the VCSEL device about 90 degrees to the waveguide. A magnetic media drive comprises the magnetic recording head assembly.

In another embodiment, a magnetic recording head assembly comprises a slider, comprising: a media facing surface, a top surface opposite the media facing surface, a trailing edge surface adjacent to the top surface, a leading edge surface opposite the trailing edge surface, an optical grating disposed on the trailing edge surface, and a heat sink stud disposed adjacent to the optical grating, a vertical cavity surface emitting laser (VCSEL) device coupled to the trailing edge surface of the slider, wherein the VCSEL device is capable of emitting a plurality of lasers that are phase coherent, and a magnetic recording head disposed on the trailing edge surface of the slider, the magnetic recording head comprising a waveguide and a near field transducer (NFT) coupled to the waveguide.

The optical grating is capable of directing light output from the VCSEL device about 90 degrees to the waveguide, and wherein the waveguide is capable of directing the output light to the NFT. The VCSEL device comprises a front surface facing the trailing edge surface of the slider and a back surface opposite the front surface, wherein a first contact pad and a VCSEL array are disposed on the front surface, and wherein a second contact pad and a third contact pad are disposed on the back surface. The first contact pad is connected to the heat sink stud, wherein the VCSEL array is aligned with the optical grating, and wherein the second contact pad is connected to the VCSEL array. The slider further comprises a plurality of contact pads on the trailing edge surface, and wherein the width of the contact pads are the same as the width of the second and third contact pads on the back surface of the VCSEL device. The slider further comprises a plurality of contact pads, and wherein a spacing between at least two of the slider contact pads is the substantially equal to a spacing between the second and third contact pads on the back surface of the VCSEL device. The plurality of lasers operate at the same frequency, wherein the plurality of lasers are output through a plurality of laser apertures, and wherein the plurality of laser apertures are linearly arranged. Each laser aperture has a size of about 1 μm to about 10 μm, wherein an output laser power per laser aperture is about 0.5 mW to about 10 mW, and wherein each laser aperture is spaced from an adjacent laser aperture a distance of about 2 μm to about 20 μm. A magnetic media drive comprises the magnetic recording head assembly.

In yet another embodiment, a magnetic recording head assembly comprises a slider, comprising: a media facing surface, a top surface opposite the media facing surface, a trailing edge surface adjacent to the top surface, a leading edge surface opposite the trailing edge surface, an optical grating disposed on the trailing edge surface, and a heat sink stud disposed adjacent to the optical grating, a vertical cavity surface emitting laser (VCSEL) device coupled to the trailing edge surface of the slider, the VCSEL device comprising: a first contact pad disposed on a front surface of the VCSEL device, the front surface facing the trailing edge surface of the slider, and a VCSEL array disposed adjacent to the first contact pad, the VCSEL array comprising a plurality of laser apertures, wherein the VCSEL device is capable of emitting a plurality of lasers that are phase coherent through the plurality of laser apertures, and a magnetic recording head disposed on the trailing edge surface of the slider, the magnetic recording head comprising a waveguide and a near field transducer (NFT) coupled to the waveguide.

The first contact pad is connected to the heat sink stud, wherein the VCSEL array is aligned with the optical grating. The optical grating is capable of directing light output from the VCSEL device about 90 degrees to the waveguide, and wherein the waveguide is capable of directing the output light to the NFT. The plurality of lasers operate at the same frequency, and wherein an output laser power per laser aperture is about 0.5 mW to about 10 mW. The plurality of laser apertures are linearly arranged, and wherein the plurality of laser apertures is 2 apertures to 32 apertures. A magnetic media drive comprises the magnetic recording head assembly.

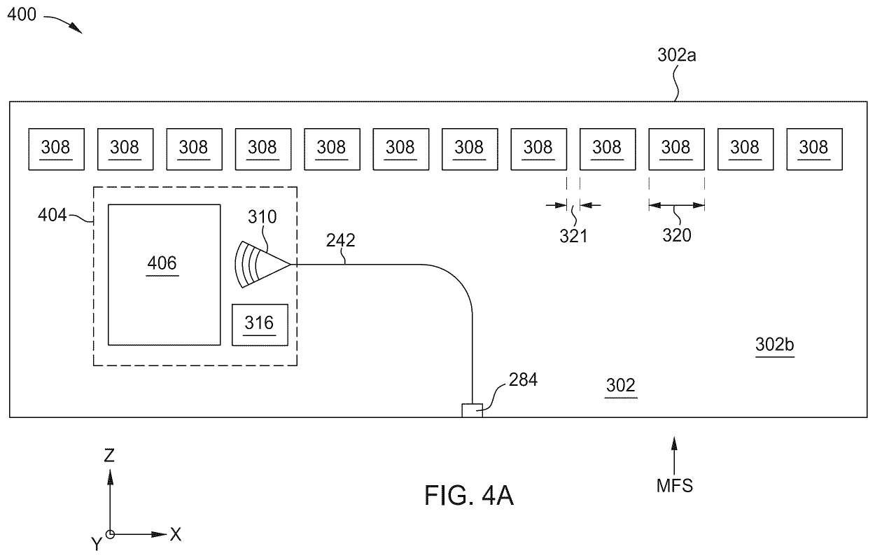

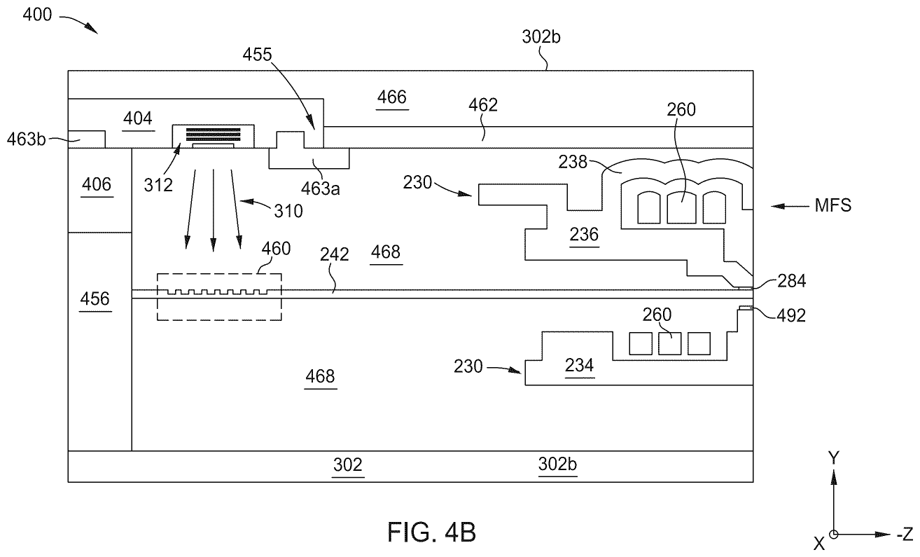

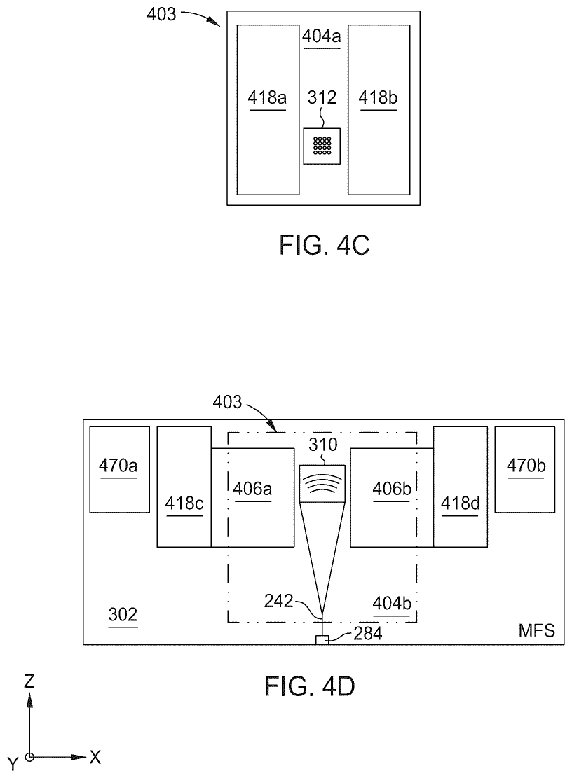

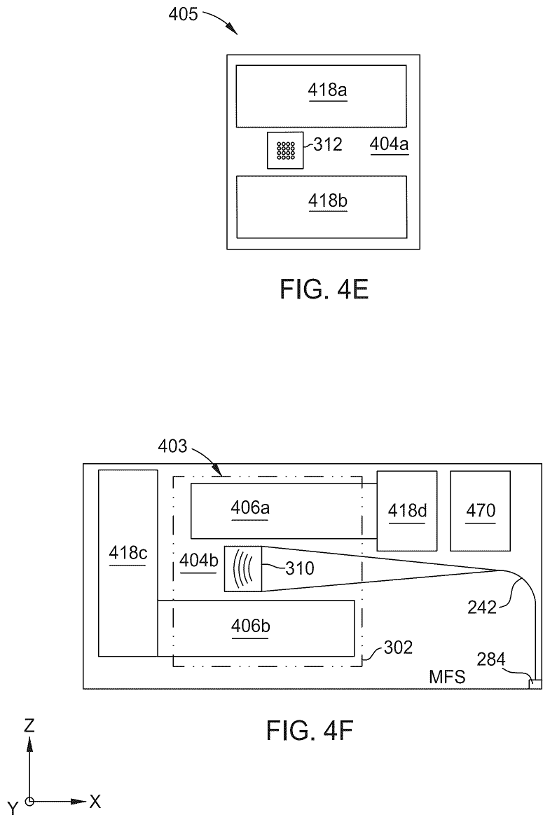

FIGS. 4A-4B illustrate a magnetic recording head assembly 400 where the VCSEL array 404 is mounted on the trailing edge 302b of the slider 302, according to another embodiment. FIG. 4A illustrates a trailing edge surface 302b view of the magnetic recording head assembly 400, and FIG. 4B illustrates a cross-sectional view of the magnetic recording head assembly 400. FIGS. 4C-4F illustrate a VCSEL device 404 of the magnetic recording head assembly 400, according to various embodiments. FIGS. 4C and 4E illustrate a front or output surface 404a (or a slider facing surface) of the VCSEL device 404 of FIG. 4, and FIGS. 4D and 4F illustrate a back surface 404b (or suspension tab facing surface) of the VCSEL device 404. The magnetic recording head assembly 400 may be used in combination with the HAMR write head 230 of FIG. 2, and may correspond to part of the reading/recording head assembly 121 described in FIG. 1 or a recording head used in other magnetic media drives. Aspects of the magnetic recording head assembly 400 may be used in combination with aspects of the magnetic recording head assembly 300 of FIGS. 3A-3D.

The magnetic recording head assembly 400 may be a laser on slider (LOS), where the VCSEL 404 is disposed on the slider 302, or a laser embedded slider (LES), where the VCSEL 404 is embedded in the slider 302 and mounted at a wafer level. The VCSEL device 404 mounted on this trailing edge surface 302b of the slider 302. The dotted line box illustrates where a VCSEL device 404 will be attached to the slider 302 on the trailing edge surface 302b, like shown in FIG. 4A.

The magnetic recording head assembly 400 of FIG. 4A is similar to the magnetic recording head assembly 300 of FIG. 3A; however, the VCSEL 404 is disposed below the row of contact pads 308, rather than within the row of contact pads 308. The magnetic recording head assembly 400 may comprise any number of contact pads 308. Moreover, the waveguide 242 is curved about 90 degrees before coupling to the NFT 284. The VCSEL 404 comprises the optical grating 310, a heat sink or heat sink stud 406, and the first electrode or contact pad 316.

Similar to the magnetic recording head 300 of FIGS. 3A-3D, the optical grating 310 directs light output from a coherent VCSEL array 312 (shown in FIGS. 4B, 4C, and 4E) into the waveguide 242. The grating 310 comprises a high index dielectric material having a repeating diffraction pattern that redirects light from the VCSEL array 312 into the waveguide 242 (i.e., in the x-direction). The grating 310 may be curved and/or blazed (e.g., wedge-shaped) to couple the laser output of the VCSEL array 312 into the tapered waveguide 242. The period of the optical grating 310 is matched to half the effective wavelength of the light, as is known in the art. The waveguide 242 then directs the light from the grating 310 to the NFT 284 at the MFS. The waveguide 242 may comprise NbOx, where x is a numeral.

As shown in the cross-sectional view of FIG. 4B, the VCSEL 404 is disposed on the trailing edge surface 302b of the slider 302. The trailing edge surface 302b optionally comprises an insulating layer 466 disposed over the VCSEL 404, such as when the VCSEL 404 is embedded in the slider 302 (LES). The optional insulating layer 466 may be excluded when the VCSEL 404 is disposed on the slider (LOS). In some embodiments, to provide additional mechanical alignment, the VCSEL 404 comprises a first notch 455 and is aligned on the slider 302 using a mechanical stop 462. The notch 455 aligns with the first mechanical stop 462. The VCSEL 404 and the mechanical stop 462 fit together such that the VCSEL 404 is perfectly aligned on the slider, such as like puzzle pieces. By utilizing the mechanical stop 462 to align the VCSEL 404 on the slider 302, the VCSEL 404 may be mounted on the slider 302 at any time, such as after the write head 230 has been fabricated. The mechanical stop 462 may comprise one or more of SiO₂, Ta₂O₅, Nb₂O₅, alumina, Cu, Au, NiFe, NiFeCo, AlN, or any dielectric material, metal, magnetic material, or ceramic material. The slider 302 may have two or more mechanical stops to align the VCSEL 404 in multiple directions. In other embodiments, different mechanical features may be used in the VCSEL and/or the slider to achieve the same alignment effect.

The slider 302 may comprise an anti-reflection coating (ARC) on the surface. The ARC reduces the reflection from the surface of the slider 302, improves the optical efficiency, and reduces the power fluctuation of the laser or VCSEL 404. The ARC may consist of multiple layers with high and low refractive index layers. For examples, the ARC may consist of multiple layers of SiO₂ and Ta₂O₅, where the thickness of each layer is about 5 nm to about 500 nm.

The slider 302 further comprises a first electrode 463a and a second electrode 463b for applying a VCSEL current, or to act as pads for connecting the VCSEL 404 to the heat sink 406. The first electrode 463a is connected to one of the contact pads 308. The first and second electrodes 463a, 463b are disposed on the trailing edge surface 302b of the slider 302, and may comprise one or more of Au, AuSn, Ti, Pt, or any material with a high conductivity. The electrodes 463a, 463b may comprise multiple layers with different materials. The insulating layer 466 may comprise alumina, for example.

The first heat sink 406 is disposed in contact with a portion of the VCSEL 404, and the first heat sink 406 is disposed opposite the MFS. The first heat sink 406 may comprise one or more of Cu, Au, Al, Ag, AlN, or any material with a high thermal conductivity. A second heat sink or an electrical contact 456 is disposed adjacent to the first heat sink 406 and is disposed in contact with the waveguide 242 at the surface opposite the MFS. The second head sink 456 may comprise one or more of the same materials as the first heat sink 406. The cladding layer 468 may comprise one or more of alumina, SiO₂, SiOxNy, where x and y are numerals, or any material with a refractive index lower than that of the waveguide core. The waveguide 242 is surrounded by cladding material 468, which may comprise alumina, for example. The waveguide 242 extends from the second heat sink 456 to the NFT 284 at the MFS. The NFT 284 is disposed on a first side of the waveguide 242, and an optional NFT mirror 284 may be disposed on a second side of the waveguide 242 opposite the first side. The NFT mirror 492 is disposed at the MFS and may be used to reflect light from the waveguide 242 into the NFT 284.

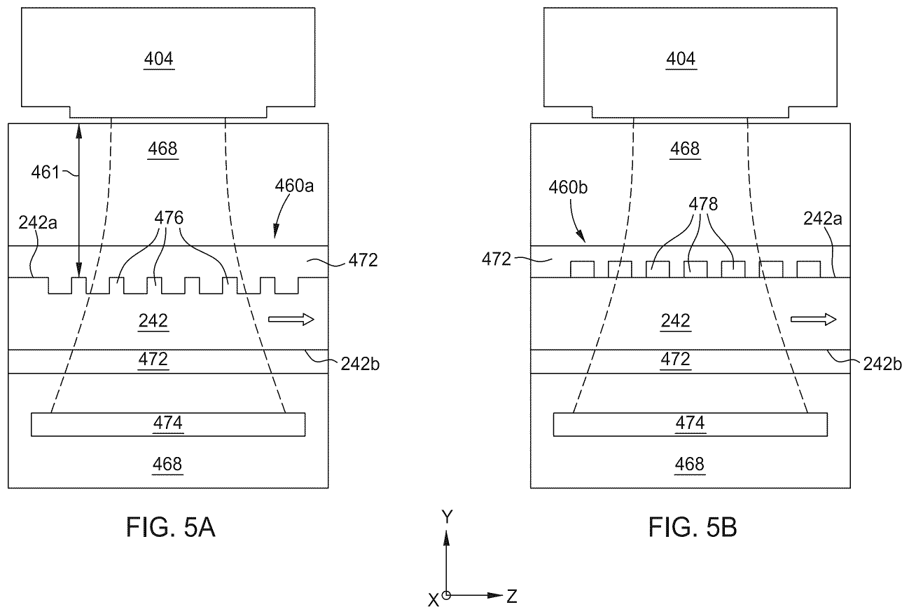

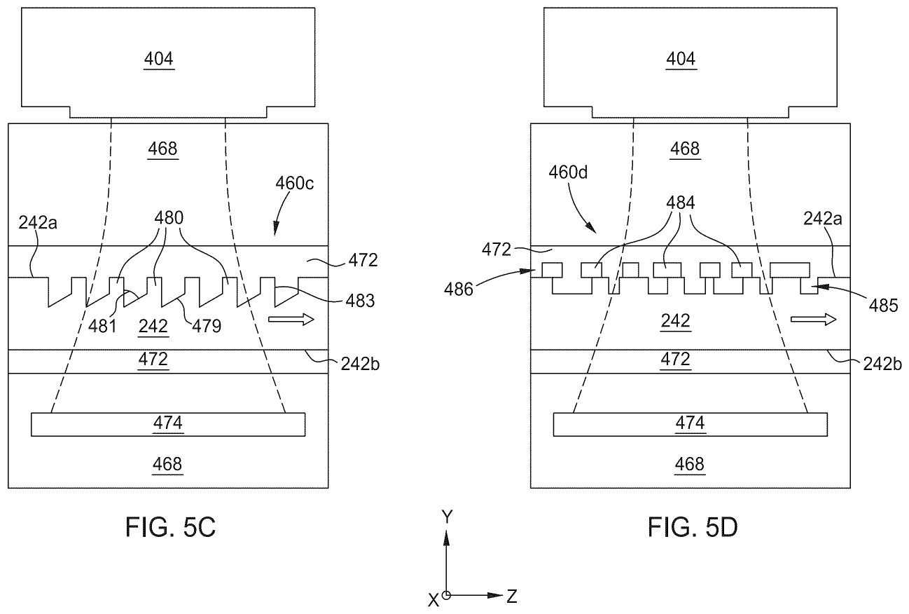

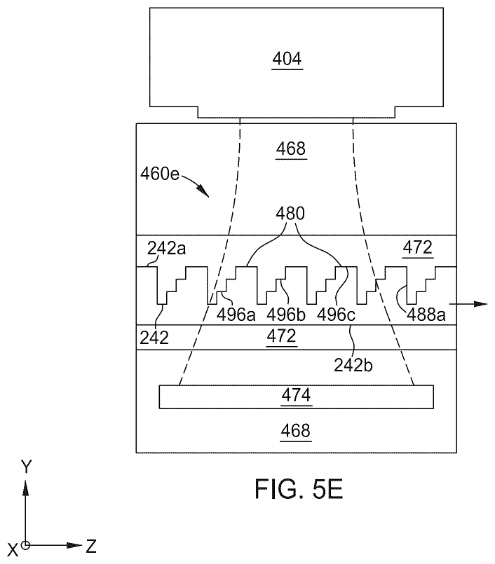

When the VCSEL array 312 output lights to the grating 310, the grating directs the light into a grating active area 460 of the waveguide 242. The waveguide 242 then directs the light to the NFT 284, as discussed above. The grating active area 460 of the waveguide 242 is aligned with the grating 310, and may have various designs, as discussed below in FIGS. 5A-5D. The shape of the grating 310 can be either straight or curved.

FIGS. 4C and 4D illustrate a first VCSEL design 403 that can be used for the VCSEL 404 of FIGS. 4A-4B, according to one embodiment. FIG. 4C illustrates a front or output surface 404a (or a slider facing surface) of the VCSEL device 403, and FIG. 4D illustrates a transparent view through a back surface 404b (or suspension tab facing surface) of the VCSEL device 403, into the trailing edge or suspension tab facing surface of the slider 302, to show how its elements align with the elements from the front or output surface of the VCSEL 403. The back surface 404b is opposite the front surface 404a of the VCSEL device 403.

As shown in FIG. 4C, the coherent VCSEL array 312 is disposed between a second contact pad or electrode 418a and a third contact pad or electrode 418b. The second and third contact pads 418a, 418b are each connected to the slider 302 and to the laser diode of the VCSEL array 312 to allow current to flow through the laser diode. The second and third contact pads 418a, 418b connect to the laser diode of the VCSEL array 312 to energize the lasers of the VCSEL array 312. In the VCSEL design 403, the second and third contact pads 418a, 418b are arranged linearly in the x-direction with the VCSEL array 312. The second and third contact pads 418a, 418b may have the same dimensions and spacing as the plurality of contact pads 308.

As shown in FIG. 4D, looking through the suspension tab facing surface 404b of the VCSEL 403 into the slider 302 302 (the dotted box shows the footprint of the VCSEL 403), the slider 302 comprises fourth and fifth contact pads 418c, 418d that are disposed in contact with a first heat sink 406a and a second heat sink 406b. The first and second heat sinks 406a, 406b may form the heat sink 406 shown in FIG. 4B. When the VCSEL 403 is coupled to the slider 302, contact pads 418a and 418b shown in FIG. 4C contact the heat sinks 406a and 406b. The second and third contact pads 418c, 418d of the slider 302 are in contact with the first and second heat sinks 406a, 406b through the VCSEL 403, providing conductive paths to be formed with the contact pads 418a and 418b on the VCSEL 403 (which may correspond to negative and positive terminals for the VCSEL). The grating 310 is disposed between the first and second heat sinks 406a, 406b to help absorb excess heat generated by the grating 310 and/or VCSEL array 312. The grating 310 is aligned with the VCSEL array 312 of the VCSEL 403. In the VCSEL design 403, the heat sinks 406a, 406b and the fourth and fifth contact pads 418c, 418d are arranged linearly in the x-direction with the grating 310 and a portion of the waveguide 242 coupled to the grating 310.

A sixth contact pad 470a may optionally be disposed adjacent to the fourth contact pad 418c, and a seventh contact pad 470b may optionally be disposed adjacent to the fifth contact pad 418d. The sixth and seventh contact pads 470a, 470b may be connected to the suspension, similar to the plurality of contact pads 308, and to the laser diode of the VCSEL array 312 to allow current to flow through the laser diode. The contact pads 470a and 470b are generic pads like the contact pads 308 and may not be connected to the laser.

FIGS. 4E and 4F illustrate a second VCSEL design 405 that can be used for the VCSEL 404 of FIGS. 4A-4B, according to one embodiment. FIG. 4E illustrates a front or output surface 404a (or a slider facing surface) of the VCSEL device 403, and FIG. 4F illustrates a transparent view through a back surface 404b (or suspension tab facing surface) of the VCSEL device 405, into the trailing edge or suspension tab facing surface of the slider 302, to show how its elements align with the elements from the front or output surface of the VCSEL 405.

The VCSEL design 405 is similar to the VCSEL design 403 of FIGS. 4C-4D; however, the placement of the contact pads 418a, 418b, 418c, 418d and the heat sinks 406a, 406b are different. Moreover, only one additional contact pad 470 is included on the back surface 404b. The additional contact pad 470 may be disposed adjacent to the fifth contact pad 418d on the back surface 404b, and is connected to the suspension, similar to the plurality of contact pads 308, and to the laser diode of the VCSEL array 312 to allow current to flow through the laser diode. In the VCSEL design 405, the second and third contact pads 418a, 418b are arranged linearly in the z-direction with the VCSEL array 312 on the front surface 404a.

As shown in FIG. 4F, looking through the suspension tab facing surface 404b of the VCSEL 405 into the slider 302 (the dotted box shows the footprint of the VCSEL 405), the slider 302 comprises fourth and fifth contact pads 418c, 418d. When the VCSEL 405 is coupled to the slider 302, contact pads 418a and 418b shown in FIG. 4C contact the heat sinks 406a and 406b. The fourth contact pad 418c of the slider 302 is disposed in contact with the first heat sink 406a through the VCSEL 405, and the fifth contact pad 418d of the slider 302 is disposed in contact with the second heat sink 406b through the VCSEL 405, providing conductive paths to be formed with the contact pads 418a and 418b on the VCSEL 405 (which may correspond to negative and positive terminals for the VCSEL). The fourth contact pad 418c and the first heat sink 406a form an L-like shape, and the fifth contact pad 418d and the second heat sink 406b form an L-like shape. The fourth contact pad 418c is disposed adjacent to the grating 310 in the x-direction. The fifth contact pad 418d is disposed adjacent to the waveguide 242 in z-direction. The grating 310 is aligned with the VCSEL array 312 of the VCSEL 405. The grating 310 and a portion of the waveguide 242 coupled to the grating 310 are disposed between the first and second heat sinks 406a, 406b in the z-direction to help absorb excess heat generated by the grating 310 and/or VCSEL array 312. The first and second heat sinks 406a, 406b may form the heat sink 406 shown in FIG. 4B. The second and third contact pads 418a, 418b are aligned over the first and second heat sinks 406a, 406b through the VCSEL 405.

FIGS. 5A-5E illustrate various grating active areas 460a, 460b, 460c, 406d of the waveguide 242 of FIGS. 4A-4B, according to various embodiments. Each grating active areas 460a, 460b, 460c, 406d may be the grating active area 460 of FIG. 4B.

FIG. 5A illustrates a first grating active area 460a, where a VCSEL facing surface 242a of the waveguide 242 comprises a plurality of rectangular grating bumps 476. The rectangular grating bumps 476 are aligned with the VCSEL array 312 of the VCSEL 404, as shown in the dotted lines, and is spaced from the VCSEL 404 a distance 461 of about 1 μm to about 40 μm. The grating of the first grating active area 460a has an area of about 10 μm×10 μm to about 100 μm×100 μm. The width of the grating depends on the number of the beams, and the distance between the VCSEL 404 and the waveguide 242. The width in the x-direction or the z-direction can be larger or smaller than the width in the other direction. The depth (i.e., height of each bump 476) is about 50 nm to about 300 nm. The pitch is about 300 nm to about 1 μm. The depth and pitch depend on the wavelength of the VCSEL 404 and the refractive indices of the waveguide core and cladding, and the depth and pitch may be larger or smaller than the range described here. The rectangular grating bumps 476 each have the same dimensions, and comprise the same material as the waveguide 242, such as NbOx, where x is a numeral. The rectangular grating bumps 476 may be cut into the waveguide 242.

The waveguide 242 may be surrounded by and in contact with transparent layers 472, such as transparent layers 472 comprising SiO₂. A mirror 474 may be disposed below a surface 242b of the waveguide 242 opposite the VCSEL facing surface 242a. The mirror 474 is aligned with the grating active area 460a and, along with the transparent layers 472, helps reflect light into the grating active area 460a. After the light is directed or reflected into the grating active area 460a, the light travels through the waveguide 242 to the NFT 284 in the direction shown by the arrow (i.e., in the y-direction).

FIG. 5B illustrates a second grating active area 460b. The second active grating area 460b is similar to the first active grating area 460a of FIG. 5A; however, the second grating active area 460b comprises a plurality of high index material rectangular (HIMR) grating bumps 478. The HIMR grating bumps 478 may comprise a-Si, TiO₂, SiN, silicon rich nitride, high-index polymers, or any other materials with high transparency and a refractive index higher than the refractive index of the core. The HIMR grating bumps 478 may each have a height in the y-direction of about 50 nm to about 300 nm, but it can be larger or smaller depending on the wavelength of the laser and the refractive indices of the waveguide core and cladding The width in the x-direction or the z-direction can be larger or smaller than the width in the other direction. The pitch is about 300 nm to about 1 μm. The depth and pitch depend on the wavelength of the VCSEL 404 and the refractive indices of the waveguide core and cladding, and the depth and pitch may be larger or smaller than the range described here. The HIMR grating bumps 478 increase the efficiency of the light direction/reflection into the waveguide 242. The HIMR grating bumps 478 are disposed on the waveguide 242, rather than cut into the waveguide, as the HIMR grating bumps 478 comprise a different material than the waveguide 242.

FIG. 5C illustrates a third grating active area 460c. The third active grating area 460c is similar to the first active grating area 460a of FIG. 5A; however, the third grating active area 460c comprises a plurality of trapezoidal or triangular grating bumps 480. The trapezoidal or triangular grating bumps 480 each comprises a surface 479 disposed at an angle 481 of about 20 degrees to about 80 degrees with respect to a surface 483 of an adjacent trapezoidal or triangular grating bump 480. The surface 483 is substantially parallel to the MFS, and faces the MFS (the MFS is in the y-direction, or towards the direction the arrow is pointing). The various dimensions of the third grating active area 460c are the same as discussed above in FIGS. 5A-5B. The trapezoidal or triangular grating bumps 480 may comprise the same material as the waveguide, or the trapezoidal grating bumps 480 may comprise a high index material. The surface 479 is opposite the surface 483. The trapezoidal or triangular grating bumps 480 increase the efficiency of the light direction/reflection into the waveguide 242. The trapezoidal or triangular grating bumps 480 may be cut into the waveguide, and comprise the same material as the waveguide 242.

FIG. 5D illustrates a fourth grating active area 460d. The fourth grating active area 460d is similar to the first active grating area 460a of FIG. 5A; however, the fourth grating active area 460d comprises a first row 485 of rectangular grating bumps 482 and a second row 486 of rectangular grating bumps 484 disposed on the first row 485. One or more rectangular grating bumps 482 of the first row 485 may have a different width, and one or more rectangular grating bumps 484 of the second row 486 may have a different width. Moreover, one or more rectangular grating bumps 482 of the first row 485 may have a different width than one or more rectangular grating bumps 484 of the second row 486. The second row 486 may be offset from the first row 485 such that the rectangular grating bumps 484 of the second row 486 are offset from the rectangular grating bumps 482 of the first row 485 that they are disposed on.

In one embodiment, the rectangular grating bumps 482 of the first row 485 and the rectangular grating bumps 484 of the second row 486 comprise the same material, such as the same material as the waveguide or a high index material. In another embodiment, the rectangular grating bumps 482 of the first row 485 and the rectangular grating bumps 484 of the second row 486 comprise different materials. For example, the rectangular grating bumps 482 of the first row 485 may comprise the same material as the waveguide 242, and the rectangular grating bumps 484 of the second row 486 may comprise a high index material, such as a-Si. The rectangular grating bumps 482 of the first row 485 and the rectangular grating bumps 484 of the second row 486 may each be cut into the waveguide 242, or the rectangular grating bumps 482 of the first row 485 may be cut into the waveguide 242 while the rectangular grating bumps 484 of the second row 486 are disposed on rectangular grating bumps 482 of the first row 485 and are not cut into the waveguide.

The various dimensions of the grating active area 460d are the same as discussed above in FIGS. 5A-5C. The offset rows 485, 486 of rectangular grating bumps 482, 484 increase the efficiency of the light coupling into the waveguide 242.

FIG. 5E illustrates a fifth grating active area 460e. The fifth active grating area 460e is similar to the third active grating area 460c of FIG. 50; however, the fifth grating active area 460e comprises a plurality of stepped plateau-like grating bumps 488. The stepped plateau-like grating bumps 488 each comprise a linear surface 488a substantially parallel to the MFS that faces the MFS (the MFS is in the y-direction, or towards the direction the arrow is pointing). The stepped plateau-like grating bumps 488 each further comprise one or more steps 496a, 496b, 496c disposed on the surface opposite the surface 488a. Each step 496a, 496b, 496c may have a width in the y-direction of about 100 nm to about 300 nm, and a depth in the z-direction of about 30 nm to about 150 nm. The width and depth depend on the wavelength, the waveguide material, and the number of steps, and the width and depth may be smaller or larger than the values described here. While three steps 496a, 496b, 496c are shown, any number of steps may be included.

The other various dimensions of the fifth grating active area 460e are the same as discussed above in FIGS. 5A-5D. The stepped plateau-like grating bumps 488 may comprise the same material as the waveguide, or the stepped plateau-like grating bumps 488 may comprise a high index material. The stepped plateau-like grating bumps 488 increase the efficiency of the light direction/reflection into the waveguide 242. The stepped plateau-like grating bumps 488 may be cut into the waveguide, and comprise the same material as the waveguide 242.

FIGS. 6A-6F illustrate light output designs 690a, 690b, 690c, 690d, 690e, 690f of the waveguide 242 of FIGS. 4A-4B, according to various embodiments. The light output designs 690a, 690b, 690c, 690d, 690e, 690f of the waveguide 242 output light to the NFT 284 at the MFS. The number of light outputs 692, 692a, 692b may be larger or smaller than that shown in FIGS. 6A-6F.

FIG. 6A illustrates a first light output design 690a. The first light output design 690a is a 1D array that outputs light in-phase. The first light output design 690a comprises two or more outputs 692 that are linearly arranged horizontally. When the outputs 692 of the first light output design 690a output light to the NFT 284, the outputs 692 collectively form one beam of light.

FIG. 6B illustrates a second light output design 690b. The second light output design 690b is a 1D array that outputs light in-phase. The second light output design 690b comprises two or more outputs 692 that are linearly arranged vertically. When the outputs 692 of the second light output design 690b output light to the NFT 284, the outputs 692 collectively form one beam of light.

FIG. 6C illustrates a third light output design 690c. The third light output design 690c is a 2D array that outputs light in-phase. The third light output design 690c comprises four or more outputs 692 that are arranged in a 3×3 square. When the outputs 692 of the third light output design 690c output light to the NFT 284, the outputs 692 collectively form one beam of light.

FIG. 6D illustrates a fourth light output design 690d. The fourth light output design 690d is a 2D array that outputs light in-phase. The fourth light output design 690d comprises four or more outputs 692 that are arranged in a circle.

When the outputs 692 of the fourth light output design 690d output light to the NFT 284, the outputs 692 collectively form one beam of light.

FIG. 6E illustrates a fifth light output design 690e. The fifth light output design 690e is a 2D array that outputs light in-phase. The fifth light output design 690e comprises four or more outer outputs 692a that are arranged in a circle, and two or more inner outputs 692b arranged in a circle without the 8 outer outputs 962a. When the outputs 692a, 692b of the fourth light output design 690d output light to the NFT 284, the outputs 692a, 692b collectively form one beam of light.

FIG. 6F illustrates a sixth light output design 690f. The sixth light output design 690f is a 1D array that outputs light out-of-phase into an s-bend to adjust the phase and a multi-mode interferometer (MMI) (not shown), which then directs the light to the NFT; however, the output may be in-phase as well. The waveguide 242 having the sixth light output design 690f splits into four legs 642, where each leg 462 comprises one light output 692. The outputs 692 of each leg are linearly arranged horizontally. When the outputs 692 of the sixth light output design 690f output light to the NFT 284, the outputs 692 collectively form one beam of light. The legs 462 are shown as connected to the waveguide 242; however, they may be spaced from the waveguide 242 (i.e., disconnected).

Therefore, by utilizing a VCSEL that is embedded in a slider or disposed on a slider, the VCSEL having any of the above discussed light output designs, grating active area designs, and/or heat sink/contact pad designs, the efficiency of directing light to the NFT is improved and optimized. As such, the magnetic recording head is more efficient, and heat is able to better absorbed and/or directed to prevent damaging the NFT.

In one embodiment, a magnetic recording head assembly comprises a slider, comprising: a media facing surface, a top surface opposite the media facing surface, a trailing edge surface adjacent to the top surface, a leading edge surface opposite the trailing edge surface, and an optical grating disposed on the trailing edge surface, a vertical cavity surface emitting laser (VCSEL) device coupled to the trailing edge surface of the slider, the VCSEL device disposed over the optical grating, and a magnetic recording head disposed on the trailing edge surface of the slider, the magnetic recording head comprising a waveguide, wherein the waveguide comprises: a grating active area aligned with the optical grating, the grating active comprising a plurality of grating bumps, and a light output pattern.

The plurality of grating bumps comprise a same material as the waveguide. The plurality of grating bumps comprise a high index material. The plurality of grating pattern comprises a first plurality of grating bumps disposed in a first row, and a second plurality of grating bumps disposed in a second row, the second row being disposed on the first row. One or more rectangular grating bumps of the first plurality of grating bumps have different dimensions, and wherein one or more grating bumps of the second plurality of rectangular grating bumps have different dimensions. The plurality of grating two or more are trapezoidal or triangular in shape. The light output pattern comprises two or more linearly arranged in-phase light outputs. The light output pattern comprises four or more in-phase light outputs arranged in a square. The light output pattern comprises eight or more in-phase light outputs arranged in a circle. A magnetic media drive comprises the magnetic recording head assembly.

In another embodiment, a magnetic recording head assembly comprise a slider, comprising: a media facing surface, a top surface opposite the media facing surface, a trailing edge surface adjacent to the top surface, a leading edge surface opposite the trailing edge surface, an optical grating disposed on the trailing edge surface, and a mechanical stop disposed adjacent to the optical grating, a vertical cavity surface emitting laser (VCSEL) device coupled to the trailing edge surface of the slider, the VCSEL device comprising a notch, wherein the notch aligns with the mechanical stop, and a magnetic recording head disposed on the trailing edge surface of the slider, the magnetic recording head comprising a waveguide.

The light output pattern outputs out-of-phase light. The VCSEL device comprises a front surface facing the trailing edge surface of the slider and a back surface opposite the front surface, wherein a first contact pad, a second contact pad, and a VCSEL array are disposed on the front surface. The slider further comprises a first heat sink and a second heat sink, wherein the first contact pad is aligned over the first heat sink, and the second contact pad is aligned over the second heat sink. The optical grating is disposed between the first heat sink and the second heat sink. The slider further comprises a first contact pad and a second contact pad, wherein the first contact pad is disposed in contact with the first heat sink and the second contact pad is disposed in contact with the second heat sink. The first contact pad and the first heat sink form an L-like shape, and wherein the second contact pad and the second heat sink form an L-like shape. A magnetic media drive comprises the magnetic recording head assembly.

In yet another embodiment, a magnetic recording head assembly a slider, comprising: a media facing surface, a top surface opposite the media facing surface, a trailing edge surface adjacent to the top surface, a leading edge surface opposite the trailing edge surface, an optical grating disposed on the trailing edge surface, one or more heat sinks disposed adjacent to the optical grating, and a mechanical stop disposed adjacent to the optical grating, a vertical cavity surface emitting laser (VCSEL) device coupled to the trailing edge surface of the slider, the VCSEL device comprising a notch and one or more contact pads, wherein the notch aligns with the mechanical stop, and wherein the one or more contact pads align over the one or more heat sinks, and the magnetic recording head comprising a waveguide, wherein the waveguide comprises: a grating active area aligned with the optical grating, the grating active comprising a plurality of grating bumps, and a light output pattern.

The VCSEL device is embedded in the slider. The VCSEL device is disposed on the slider. The plurality of grating pattern comprises a first plurality of grating bumps disposed in a first row, and a second plurality of grating bumps disposed in a second row, the second row being disposed on the first row, wherein one or more rectangular grating bumps of the first plurality of grating bumps have different dimensions, and wherein one or more grating bumps of the second plurality of rectangular grating bumps have different dimensions. The light output pattern outputs out-of-phase light. The plurality of grating bumps comprise a first surface parallel to the media facing surface, and a second surface opposite the first surface, the second surface comprising one or more steps. A magnetic media drive comprises the magnetic recording head assembly.

While the foregoing is directed to embodiments of the present disclosure, other and further embodiments of the disclosure may be devised without departing from the basic scope thereof, and the scope thereof is determined by the claims that follow.

What is claimed is:

1. A magnetic recording head assembly, comprising:
a slider, comprising:
a media facing surface;
a top surface opposite the media facing surface;
a trailing edge surface adjacent to the top surface;
a leading edge surface opposite the trailing edge surface; and
an optical grating disposed on the trailing edge surface;
a vertical cavity surface emitting laser (VCSEL) device coupled to the trailing edge surface of the slider, the VCSEL device disposed over the optical grating; and
a magnetic recording head disposed on the trailing edge surface of the slider, the magnetic recording head comprising a waveguide, wherein the waveguide comprises:
a grating active area aligned with the optical grating, the grating active comprising a plurality of grating bumps; and
a light output pattern.

2. The magnetic recording head assembly of claim 1, wherein the plurality of grating bumps comprise a same material as the waveguide.

3. The magnetic recording head assembly of claim 1, wherein the plurality of grating bumps comprise a high index material.

4. The magnetic recording head assembly of claim 1, wherein the plurality of grating pattern comprises a first plurality of grating bumps disposed in a first row, and a second plurality of grating bumps disposed in a second row, the second row being disposed on the first row.

5. The magnetic recording head assembly of claim 4, wherein one or more rectangular grating bumps of the first plurality of grating bumps have different dimensions, and wherein one or more grating bumps of the second plurality of rectangular grating bumps have different dimensions.

6. The magnetic recording head assembly of claim 1, wherein the plurality of grating bumps are trapezoidal or triangular in shape.

7. The magnetic recording head assembly of claim 1, wherein the light output pattern comprises two or more linearly arranged in-phase light outputs.

8. The magnetic recording head assembly of claim 1, wherein the light output pattern comprises two or more in-phase light outputs arranged in a square.

9. The magnetic recording head assembly of claim 1, wherein the light output pattern comprises four or more or more in-phase light outputs arranged in a circle.

10. A magnetic media drive comprising the magnetic recording head assembly of claim 1.

11. A magnetic recording head assembly, comprising:
a slider, comprising:
a media facing surface;
a top surface opposite the media facing surface;
a trailing edge surface adjacent to the top surface;
a leading edge surface opposite the trailing edge surface;
an optical grating disposed on the trailing edge surface; and
a mechanical stop disposed adjacent to the optical grating;
a vertical cavity surface emitting laser (VCSEL) device coupled to the trailing edge surface of the slider, the VCSEL device comprising a notch, wherein the notch aligns with the mechanical stop; and
a magnetic recording head disposed on the trailing edge surface of the slider, the magnetic recording head comprising a waveguide.

12. The magnetic recording head assembly of claim 11, wherein light output pattern outputs out-of-phase light.

13. The magnetic recording head assembly of claim 11, wherein the VCSEL device comprises a front surface facing the trailing edge surface of the slider and a back surface opposite the front surface, wherein a first contact pad, a second contact pad, and a VCSEL array are disposed on the front surface.

14. The magnetic recording head assembly of claim 13, wherein the slider further comprises a first heat sink and a second heat sink, wherein the first contact pad is aligned over the first heat sink, and the second contact pad is aligned over the second heat sink.

15. The magnetic recording head assembly of claim 14, wherein the optical grating is disposed between the first heat sink and the second heat sink.

16. The magnetic recording head assembly of claim 14, wherein the slider further comprises a first contact pad and a second contact pad, wherein the first contact pad is disposed in contact with the first heat sink and the second contact pad is disposed in contact with the second heat sink.

17. The magnetic recording head assembly of claim 16, wherein the first contact pad and the first heat sink form an L-like shape, and wherein the second contact pad and the second heat sink form an L-like shape.

18. A magnetic media drive comprising the magnetic recording head assembly of claim 11.

19. A magnetic recording head assembly, comprising:
a slider, comprising:
a media facing surface;
a top surface opposite the media facing surface;
a trailing edge surface adjacent to the top surface;
a leading edge surface opposite the trailing edge surface;
an optical grating disposed on the trailing edge surface;
one or more heat sinks disposed adjacent to the optical grating; and
a mechanical stop disposed adjacent to the optical grating;
a vertical cavity surface emitting laser (VCSEL) device coupled to the trailing edge surface of the slider, the VCSEL device comprising a notch and one or more contact pads, wherein the notch aligns with the mechanical stop, and wherein the one or more contact pads align over the one or more heat sinks; and
the magnetic recording head comprising a waveguide, wherein the waveguide comprises:
a grating active area aligned with the optical grating, the grating active comprising a plurality of grating bumps; and
a light output pattern.

20. The magnetic recording head assembly of claim 19, wherein the VCSEL device is embedded in the slider.

21. The magnetic recording head assembly of claim 19, wherein the VCSEL device is disposed on the slider.

22. The magnetic recording head assembly of claim 19, wherein the plurality of grating pattern comprises a first plurality of grating bumps disposed in a first row, and a second plurality of grating bumps disposed in a second row, the second row being disposed on the first row, wherein one or more rectangular grating bumps of the first plurality of grating bumps have different dimensions, and wherein one or more grating bumps of the second plurality of rectangular grating bumps have different dimensions.

23. The magnetic recording head assembly of claim 19, wherein light output pattern outputs out-of-phase light.

24. The magnetic recording head assembly of claim 19, wherein the plurality of grating bumps comprise a first surface parallel to the media facing surface, and a second surface opposite the first surface, the second surface comprising one or more steps.

25. A magnetic media drive comprising the magnetic recording head assembly of claim 19.
